(19) United States
(12) Patent Application Publication
(10) Pub. No.: US 2011/0150413 A1
(43) Pub. Date: Jun. 23, 2011

(54) MOVING PICTURE RECORDING/REPRODUCING APPARATUS AND METHOD

(75) Inventor: Seung Chul JEON, Ansan-si (KR)

(73) Assignee: Samsung Electronics Co., Ltd., Suwon-si (KR)

(21) Appl. No.: 12/967,316

(22) Filed: Dec. 14, 2010

(30) Foreign Application Priority Data
Dec. 18, 2009 (KR) 2009-126743

(51) Int. Cl. H04N 5/92; H04N 5/775

(52) U.S. Cl. 386/230; 386/337; 386/E05.024; 386/E05.07

(57) ABSTRACT

A method to record or reproduce a moving picture includes generating main video streams when a moving picture is photographed, lowering a resolution of the main video streams so as to generate sub video streams, multiplexing the main video streams and the sub video streams so as to generate one file, and storing the generated file. Since only the sub video streams obtained by lowering the resolution of I-frames are displayed on the display unit, a picture decoding time is shortened and a picture may be rapidly and easily browsed and edited.

### CROSS-REFERENCE TO RELATED APPLICATIONS

This application claims the benefit of priority under 35 U.S.C. §119 to Korean Patent Application No. 2009-0126743, filed on Dec. 18, 2009 in the Korean Intellectual Property Office, the disclosure of which is incorporated herein by reference in its entirety.

### BACKGROUND

1. Field of the Invention

Embodiments of the present general inventive concept relate to a moving picture recording/reproducing apparatus and method, which enable browsing and editing of picture data.

2. Description of the Related Art

A moving picture recording/reproducing apparatus converts an analog moving picture signal into a digital signal so as to process the signal, stores digital moving picture data generated as the result of processing the signal in a frame memory, compresses the stored moving picture data using a software or hardware compression circuit, and stores the compressed data in a storage medium. The moving picture apparatus may be a video camera or other moving picture recording/reproducing apparatus.

The moving picture recording/reproducing apparatus may reproduce the moving picture stored in the storage medium using a display unit mounted therein without transmitting the moving picture to a television receiver, a computer, or the like.

As display units mounted in moving picture recording/reproducing has apparatuses have been developed, the resolution of captured and displayed moving pictures has rapidly increased. In Standard Definition (SD), the resolution is 721*450 pixels according to the National Television System Committee (NTSC) standard and is 721*576 pixels according to the Phase Alternating Line (PAL) standard. In High Definition (HD), the resolution is 1250*721 (HD) pixels and 1921×1050 (Full-HD) pixels. As the resolution of the display unit of the moving picture recording/reproducing apparatus has increased, the size of a corresponding moving picture file has increased and thus the storage capacity of the storage medium has needed to be increased.

The moving picture stored in the moving picture recording/reproducing apparatus may be edited. A desired portion of the moving picture may be selected for editing by browsing the moving picture and separating a portion of the moving picture stream or file from the remainder of the stream or file. The edited portion that is separated may have been erroneously photographed or may not be preferred, or may be combined with another portion, according to the constraints of the storage capacity of the storage medium or user's intention. The moving picture may be removed or edited in a digital picture processing apparatus or a computer, such as a personal computer.

Since the size of the moving picture data is large and the performance of a processor (Central Processing Unit (CPU)) used to process the moving picture data is low, the moving picture recording/reproducing apparatus may not be capable of rapidly editing and browsing the moving picture.

That is, in order to browse and edit a moving picture at full-HD resolution, all data at resolution of 1921*1050 pixels are processed and displayed on the display unit. At this time, since all the frames of the moving picture are decoded, overall processing speed may be decreased.

### SUMMARY

Therefore, it is an aspect of the present general inventive concept to provide a moving picture recording/reproducing apparatus and method, which enable browsing and editing of a moving picture.

Additional aspects and utilities of the general inventive concept will be set forth in part in the description which follows and, in part, will be obvious from the description, or may be learned by practice of the general inventive concept.

Features and/or utilities of the present general inventive concept may be realized by a moving picture recording/reproducing method including generating main video streams when a moving picture is photographed, lowering a resolution of the main video streams so as to generate sub video streams, multiplexing the main video streams and the sub video streams so as to generate one file, and storing the generated file.

The generating of the sub video streams may include extracting I-frames from the main video streams, and lowering a resolution of the I-frames to a predetermined resolution.

The predetermined resolution may be 160*90 or less.

The generating of one file may include generating a moving picture file including dual streams.

The generating of one file may include generating an MP4 file.

The moving picture recording/reproducing method may further include determining whether a user inputs a browsing instruction, and decoding and displaying the sub video streams if it is determined that the user inputs the browsing instruction.

The moving picture recording/reproducing method may further include determining whether the user inputs an editing instruction, determining whether a picture to be edited is selected if it is determined that the user inputs the editing instruction, and dividing the selected picture from the file if it is determined that the picture to be edited is selected.

The moving picture recording/reproducing method may further include removing or pasting the separated picture according to an instruction of the user.

The decoding and displaying of the sub video streams may include decoding and displaying the main video streams.

In accordance with another aspect of the present general inventive concept, there is provided a moving picture recording/reproducing apparatus including a stream generator to generate main video streams of a photographed moving picture and to lower a resolution of the main video streams so as to generate sub video streams, a file generator to multiplex the main video streams and the sub video streams so as to generate one file, a storage unit to record and store the file, and a display unit to reproduce the file.

The moving picture recording/reproducing apparatus may further include an input unit to enable a user to input a browsing instruction and an extractor to extract the main video streams and the sub video streams from the file when the browsing instruction is input, and the display unit may display the sub video streams.

The moving picture recording/reproducing apparatus may further include an input unit to enable a user to input an editing instruction an extractor to extract the main video streams and the sub video streams from the file when the editing instruction is input, and an editing unit to separate a selected picture from the file so as to regenerate a file when the user selects a picture to be edited. The display unit may display the extracted sub video streams, and the storage unit may re-record the regenerated file.

The stream generator may generate dual streams at Standard Definition (SD) or High Definition (HD).

The stream generator may extract I-frames from the main video streams and lower a resolution of the I-frames to a predetermined resolution.

The predetermined resolution may be 160*90 or less.

The display unit may include a first display region in which the main video streams are reproduced and a second display region in which the sub video streams are reproduced.

The file generator may generate the main video streams in a chunk form of an MP4 file and generate the sub video streams in a user-defined type of the MP4 file.

The file generator may position the sub video streams at positions close to the I-frames of the main video streams.

According to an embodiment of the present general inventive concept, since only the sub video streams obtained by lowering the resolution of the I-frames are displayed on the display unit in order to browse and edit the moving picture, picture decoding proceeds more rapidly and thus the moving picture may be rapidly and easily browsed and edited.

Features and/or utilities of the present general inventive concept may also be realized by a method of controlling a video stream including receiving moving image data, based on the moving image data, generating a first video stream at a first resolution and a second video stream at a second resolution less than the first resolution, the second video stream corresponding to predetermined frames located at predetermined intervals within the first video stream.

The method further may include multiplexing the first video stream and the second video stream into a single file.

The method further may include storing the single file in a storage unit.

Multiplexing the first video stream and the second video stream may include locating a frame of the second video stream at a predetermined location with respect to a corresponding frame of the first video stream, and locating audio data at a predetermined location with respect to each of the frames of the first and second video streams.

The method further may include displaying a plurality of frames of the second video stream, receiving an input to select at least one of the frames of the second video stream, and based on the selection of the at least one frame of the second video stream, accessing at least one frame of the first video stream corresponding to the selected at least one frame of the second video stream.

The method further may include locating the frame of the second video stream immediately preceding the corresponding frame of the first video stream.

The first video stream may be generated by generating predicted frames between intra-frames that include complete images, and the second video stream may include frames that correspond only to the intra-frames of the first video stream.

Features and/or utilities of the present general inventive concept may also be realized by a method of controlling a video stream including receiving moving image data, based on the moving image data, generating a first video stream at a first resolution and a second video stream at a second resolution less than the first resolution, and multiplexing the first and second video streams to generate a single file.

Features and/or utilities of the present general inventive concept may also be realized by an imaging device including a stream generator to receive moving image data, to generate a first video stream at a first resolution, and to generate a second video stream at a second resolution less than the first resolution, frames of the second video stream corresponding to frames of the first video stream located at predetermined intervals with respect to each other.

The imaging device further may include a file generator to multiplex the first and second video streams to form a single file.

The imaging device further may include a storage unit to store the single file.

The imaging device further may include a stream extractor to extract the second video stream from the single file stored in the storage unit.

The imaging device further may include an editing unit to edit a portion of the first video stream corresponding to a selected portion of the second video stream.

The imaging device further may include a display unit to display a plurality of frames of the second video stream extracted by the stream extractor.

The imaging device further may include an input unit to receive an input to select the portion of the second video stream to edit the corresponding portion of the first video stream.

The imaging device further may include a moving picture collection unit to convert received light into the moving image data.

The imaging device may include a stream generator to receive moving image data, to generate a first video stream at a first resolution, and to generate a second video stream at a second resolution based on the first video stream, and a file generator to multiplex the first video stream and the second video stream into a single file.

### BRIEF DESCRIPTION OF THE DRAWINGS

These and/or other aspects and utilities of the general inventive concept will become apparent and more readily appreciated from the following description of the embodiments, taken in conjunction with the accompanying drawings of which:

FIG. 1 is a block diagram showing the configuration of a moving picture recording/reproducing apparatus according to an embodiment of the present general inventive concept;

FIG. 2 is a diagram showing the configuration of video streams in the moving picture recording/reproducing apparatus according to the embodiment of the present general inventive concept;

FIG. 3 is a diagram showing the configuration of a moving picture file in the moving picture recording/reproducing apparatus according to the embodiment of the present general inventive concept;

FIG. 4 is a diagram showing an example of a display unit of the moving picture recording/reproducing apparatus according to the embodiment of the present general inventive concept;

FIG. 5 is a diagram showing an example of division of video streams in the moving picture recording/reproducing apparatus according to the embodiment of the present general inventive concept;

FIG. 6 is a flowchart illustrating a moving picture recording/reproducing method according to an embodiment of the present general inventive concept; and

FIGS. 7A-7F illustrate displays of main and sub video frames according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

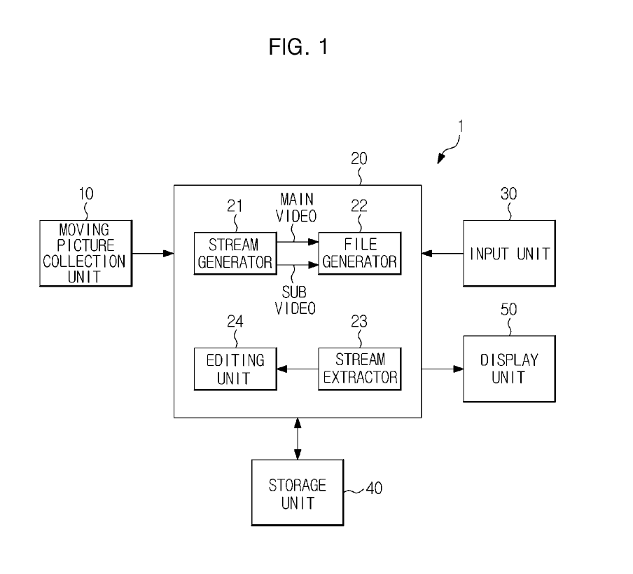

FIG. 1 is a block diagram showing the configuration of a moving picture recording/reproducing apparatus 1 according to an embodiment of the present general inventive concept. The moving picture recording/reproducing apparatus may easily and rapidly browse and edit a moving picture, and includes a moving picture collection unit 10, a controller 20, an input unit 30, a storage unit 40, and a display unit 50. The controller 20 includes a stream generator 21, a file generator 22, a stream extractor 23, and an editing unit 24.

As illustrated in FIG. 1, the moving picture collection unit 10, the controller 20, the input unit 30, and the display unit 50 may all be part of a single device 1, such as a single video camera that can capture and display moving pictures or video. Alternatively, any one or more of the moving picture collection unit 10, the input unit 30, the display unit 50, and the storage unit 40 may comprise physical devices that are separate or independent of the moving picture recording/reproducing apparatus 1 and are electrically connected to the controller 20 to perform the recording and reproducing operations described below.

Each of the components 21, 22, 23, and 24 of the controller 20 may comprise separate electronic devices, such as processors, memory, logic, converters, and multiplexers, or the components 21, 22, 23, and 24 may include software programs stored in memory that share one or more processors, memory, and logic to perform the operations of the respective components 21, 22, 23, and 24. For example, the controller 20 may comprise a single processor connected to a multiplexer of the file generator 22 to transmit data from a memory chip to the multiplexer 22, connected to an image processor of the stream generator 21 to transmit data to the stream processor 21, and connected to the storage unit 40 to transmit data to and from the components 22, 23, and 24 and the storage unit 40.

The storage unit 40 may be integral with the controller 20 or the moving picture recording/reproducing apparatus 1 or may be separate. For example, the storage unit 40 may include an optical or magnetic disc, a FLASH drive, or any other type of storage medium.

The moving picture collection unit 10 collects and transmits moving picture data to the stream generator 21 when a user inputs a moving picture photographing instruction.

The moving picture includes a plurality of continuous pictures. The plurality of pictures is continuously reproduced such that the pictures seem to move.

The moving picture collection unit 10 converts a plurality of analog picture signals into a digital picture signal so as to process the signals. The moving picture collection unit 10 may be a video camera, for example. The plurality of continuous pictures may be captured electronically, such as with a photosensitive device, or via any other image-capture device. The signal generated by the image-capture device may be an analog signal. The analog signal may be processed in an image-processing unit, analog-to-digital converter, or any other appropriate device into a digital image signal or picture data having a predetermined resolution. The moving picture collection unit 10 may include one or more storage media including magnetic, optical, or electronic storage media, such as RAM, to store and/or buffer image data corresponding to the collected moving pictures.

The picture data generated as the result of processing the signals generated by the image-capture device is transmitted to the controller 20, is encoded by the controller 20, and is stored in the storage unit 40.

The picture data may include a dual stream, and each dual stream or stream set may be matched with corresponding audio data. A plurality of stream sets may make up one moving picture file. The picture data will now be described in more detail.

The picture data from the moving picture collection unit 10 is input to the stream generator 21 of the controller 20, which generates main video streams in High Definition (HD) or Full HD (1921*1050) using the picture signals transmitted from the moving picture collection unit 10.

The stream generator 21 extracts I-frames from the main video streams, generates sub video streams by reducing a resolution of the extracted I-frames to a predetermined resolution, and transmits the generated main video streams and the sub video streams to the file generator 22.

That is, the stream generator 21 simultaneously generates the original video streams in HD or the Full HD and the sub video streams at a predetermined resolution necessary for browsing and editing. The predetermined resolution may be 160*90 or less, for example.

The main video streams correspond to the original picture collected according to a photographing instruction from the user and the sub video streams correspond to the picture of the I-frames at the predetermined resolution. The I-frames will now be described in more detail.

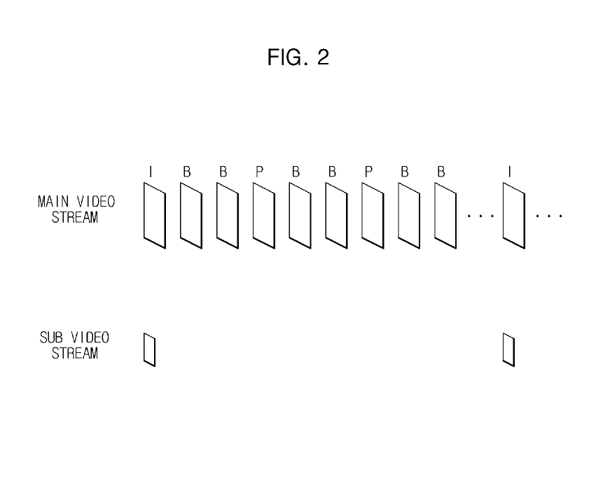

FIG. 2 is a diagram showing the configuration of video streams in the moving picture recording/reproducing apparatus according to an embodiment of the present general inventive concept.

The bit stream of a moving picture codec such as a Moving Picture Experts Group (MPEG)-2 codec, an MPEG-4 codec, or an H.264 codec has I-, B- and P-frames.

The I-frame (intra frame) is a frame having one complete picture, the P-frame (Predicted frame) is a forward predicted encoding picture between frame, which is obtained by calculating a difference between a current frame and a previous frame and encoding the difference, and the B-frame (Bi-directional frame) is a bi-directional predicted encoding picture, which is obtained by evaluating a difference between a previous frame and a subsequent frame and encoding the difference.

The I-frames extend over a plurality of frames according to the structure of the MPEG-2 codec, the MPEG-4 codec or the H.264 codec. The combination of an I-frame, the P-frames, and the B-frames subsequent to the I-frame and preceding the next I-frame constitute a Group of Pictures (GOP). That is, the Group of Pictures is made up of, a set of continuous frames from an I-frame to a frame positioned in front of a next I-frame.

The P-frame and the B-frame are picture data obtained by comparing the previous frame or the subsequent frame and the current frame and encoding the difference therebetween. Since the P-frame and the B-frame have only predicted information, they do not constitute complete pictures.

In contrast, since the I-frame has complete picture data, the I-frame may be used by a user to browse and edit the moving picture.

The sub video frames are generated by lowering the resolution of the I-frames to a predetermined resolution, and the sub video frames are used to reduce a decoding time of the moving picture when during browsing and editing operations. Thus, the moving picture may be rapidly browsed and edited. In addition, the sub video streams may be used to rapidly reproduce the moving picture.

Since the sub video streams have a low resolution and thus occupy a significantly small portion of the overall picture data, the sub video streams do not significantly affect the size of the overall moving picture.

The file generator 22 of the controller 20 generates a dual stream file including the main video frames and the sub video frames transmitted from the stream generator 21 and transmits the generated dual stream file to the storage unit 40.

The dual stream may be used for the reproduction of a Standard Definition (SD) picture and an HD picture.

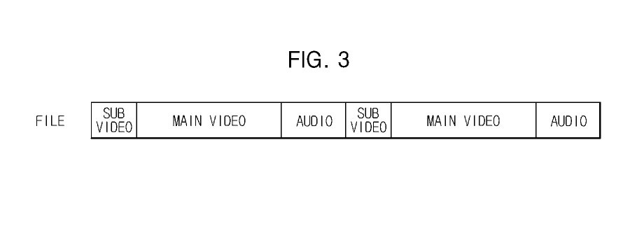

FIG. 3 is a diagram showing the configuration of a moving picture file in the moving picture recording/reproducing apparatus according to an embodiment of the present general inventive concept. As shown in FIG. 3, the moving picture file contains video data and audio data. The video data includes the main video streams and the sub video streams.

The main video streams, the sub video streams, and the audio data make up one stream set. A plurality of stream sets makes up one moving picture file.

The sub video streams may be positioned in front of the I-frames of the main video streams such that the picture is easily browsed by accessing the sub video streams.

When the moving picture file is generated, the file generator 22, may follow the MP4 file standard to multiplex the sub video stream, the main video stream, and the audio. The MP4 file has several file chunks (actual data in the continuous media data unit of the same type) within an mdat ATOM (unit configuring an MP4 file).

The main video streams and the audio data of the moving picture file are configured in a chunk type used in the MP4 file, and the sub video streams are configured in any one of user-defined types. Therefore, the moving picture recording/reproducing apparatus which does not perform the display of the sub video streams may reproduce the main video streams without error.

The input unit 30 receives the moving picture photographing, reproducing, browsing and editing instructions from the user and transmits the received instruction signals to the controller 20, enables the user to select one picture and transmits the position of the selected picture to the controller 20 when the picture is browsed and edited, and receives dividing, separating, pasting, and removing instructions from the user and transmits the received instructions to the controller 20 when the picture is edited. The input unit 30 may include a plurality of buttons or other input devices, or may comprise a touch-screen.

The storage unit 40 records and stores the file transmitted from the file generator 22 of the controller 20, extracts a file when browsing and editing instructions of any one file are transmitted from the controller 20, transmits the extracted file to the stream extractor 23 of the controller 20, and re-records an edited file transmitted from the editing unit 22 when the picture is edited.

The controller 20 controls the driving of the picture collection unit 10 so as to collect pictures configuring the moving picture when a moving picture photographing instruction signal is input through the input unit 30, controls the driving of the display unit 50 so as to reproduce the moving picture when a reproducing instruction signal is input, and controls the driving of the stream extraction unit 23 and the display unit 50 so as to extract the file selected by the user and reproduce the sub video streams when browsing and editing instruction signals are input such that the picture is browsed and edited. The controller 20 performs editing functions according to the dividing, pasting, and removing instructions input through the input unit 30 when the user selects a picture.

The control of the picture browsing and editing by the controller 20 will be described in more detail below. The stream extractor 23 of the controller 20 extracts the file selected by the user from the storage unit 40. The extracted file is separated into the main video streams and the sub video streams, and the extracted sub video streams are decoded and are transmitted to the display unit 50.

When the user selects any one sub video stream, the stream extractor 23 extracts the main video stream corresponding to the selected sub video stream, decodes the extracted main video stream, and transmits the decoded main video stream to the display unit 50.

The stream extractor 23 may simultaneously decode the main video stream and transmit the decoded main video stream to the display unit 50 when decoding the sub video stream and transmitting the decoded sub video stream to the display unit 50.

The display unit 50 reproduces (that is, displays) the file selected by the user according to the instruction of the controller 20 and reproduces the picture of the browsed and edited file.

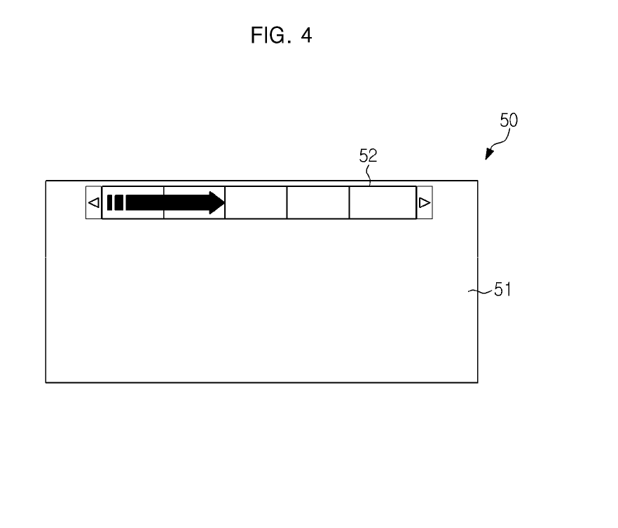

FIG. 4A is a diagram showing an example of a display unit of the moving picture recording/reproducing apparatus according to an embodiment of the present general inventive concept. The display unit 50 has a first display region 51 to display the main video streams and a second display region 52 to display the sub video streams.

When the user selects any one sub video stream, the display unit 50 displays the overall picture of the selected sub video stream in the first display region 51.

A touch screen may be used as the display unit 50. When the user touches any one picture in the second display region 52 to display the sub video streams in order to edit the moving picture, the display unit 50 transmits the touch position to the controller 20. The controller 20 analyzes the transmitted position and analyzes the picture positioned at that position as a picture to be edited.

The display unit 50 may recognize a dragging operation of the user's finger. Thus, the display unit 50 browses a previous or subsequent frame in correspondence with the dragged direction when the dragging operation of the user's finger is performed.

The second display region 52 of the display unit 50 continuously arranges and displays the current sub video frame, the previous sub video frame and the subsequent sub video frame (dual decoding), without displaying only the current sub video frame.

That is, the picture may be browsed while skipping one frame or several frames, and a user may easily browse the picture to edit a portion of the picture.

The display unit 50 may arrange only an editable frame with respect to the previous sub video frame and the subsequent sub video frame in time-series order. Since the resolution of the sub video frames is low, the sub video frames may be more rapidly displayed in the second display region 52 of the display unit 50.

Since multiple sub video streams at the predetermined resolution are displayed on the display unit 50, the picture may be rapidly browsed. The sub video streams at the predetermined resolution do not apply a heavy load to the storage unit 40. In other words, a processor of the controller 20 or the display unit 50 does not utilize as much processing power or bandwidth to access and display the sub video frames as to display the main video frames.

When the user selects any one picture while the sub video streams are reproduced in the second display region 52 of the display unit 50, the editing unit 24 recognizes the selected picture as the picture to be edited, determines the position of the recognized picture to be edited, and divides the stream set corresponding to the selected position from the file.

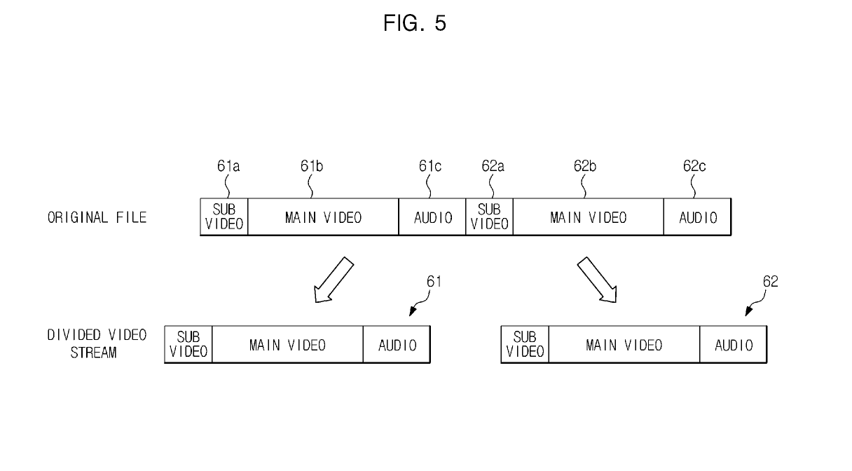

As shown in FIG. 5, the stream set is separated from the file on the basis of the selected sub video stream. A first stream set 61 includes a sub video frame 61a, a main video frame 61b, and audio 61c. A second stream set 62 includes a sub video frame 62a, a main video frame 62b, and audio 62c. If the sub video frame 62a is displayed on the display unit 50 and selected by a user, then the editing unit 24 may access the stream set in the storage unit 40 at a location corresponding to the sub video 62a to access the main video beginning at the frame 62b.

The editing unit 24 divides, pastes, and removes the picture according to the editing instruction transmitted from the input unit 30 with respect to the separated stream set 62, and generates a new moving picture file. The generated moving picture file is re-recorded and stored in the storage unit 40.

Since the main video stream is separated from the file based on the browsed position of the sub video stream so as to generate the new moving picture, the picture may be rapidly and efficiently browsed and edited.

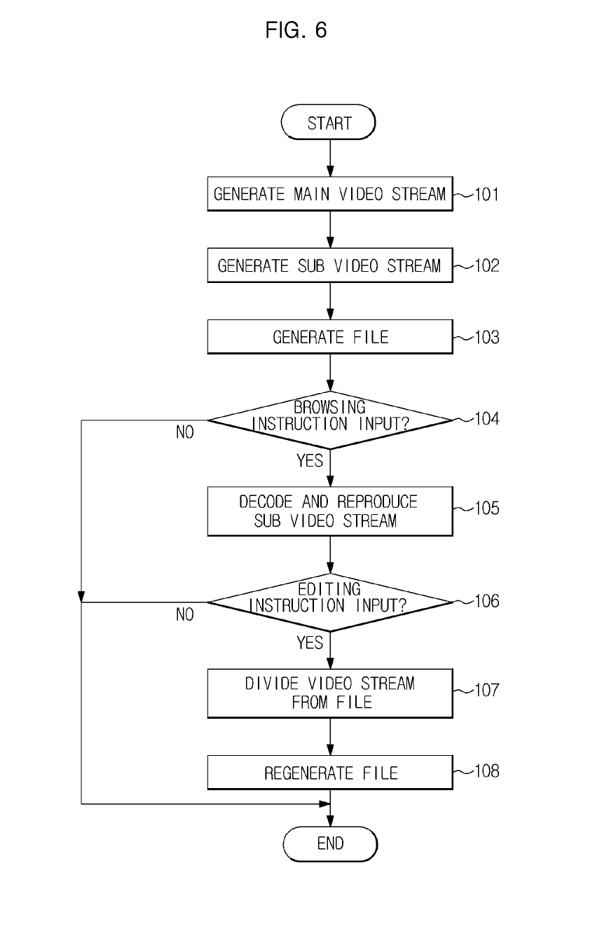

FIG. 6 is a flowchart illustrating a moving picture recording/reproducing method according to an embodiment of the present general inventive concept, which will be described with reference to FIGS. 1 to 5.

When the user inputs the moving picture photographing instruction, the moving picture data is collected.

The moving picture includes a plurality of continuous pictures. The plurality of pictures is continuously reproduced such that the pictures seem to move.

As shown in FIG. 2, the collected moving picture data is converted into the digital picture signal so as to generate the main video streams in HD or Full HD (1921*1050) in operation 101.

The I-frames are extracted from the generated main video streams, and the resolution of the extracted I-frames is lowered to the predetermined resolution so as to generate the sub video streams in operation 102.

The main video streams correspond to an original picture collected according to the photographing instruction of the user and the sub video streams correspond to the picture of the I-frames at the predetermined resolution less than the resolution of the main video. The original video streams in HD or Full HD or the sub video streams at the predetermined resolution necessary for browsing and editing are simultaneously generated.

When the moving picture is browsed and edited, the sub video frames generated by lowering the resolution of the I-frames to the predetermined resolution are decoded and displayed such that a picture display time is shortened.

Since the sub video streams are at the predetermined resolution and thus occupy a significantly small portion of the overall picture data, the sub video streams do not influence the storage size of the overall moving picture.

In addition, since the P-frame and the B-frame are picture data obtained by comparing the previous frame or the subsequent frame and the current frame and encoding the difference therebetween, the P-frames and the B-frames are not used to generate the sub video. Instead, only the I-frames having the complete picture data are used.

As shown in FIG. 3, in operation 103 one file is generated using the dual stream including the generated main video streams and sub video streams. The moving picture file in which a plurality of dual streams is continuously arranged is stored in the storage unit 40.

As shown in FIG. 3, each of the pictures of the moving picture file is composed of the dual stream. The dual stream together with audio data make up one stream set, and a plurality of stream sets make up one moving picture file.

The file further includes the audio data in addition to the main video streams and the sub video streams. The sub video streams are positioned close to the main video streams. More specifically, the sub video streams may be positioned in front of the I-frames of the main video frames such that the picture is easily browsed by accessing the sub video stream.

When the moving picture file is generated, multiplexing (muxing) follows the MP4 file container standard. The MP4 file has several file chunks within an mdat ATOM (unit configuring the MP4 file).

The main video streams and the audio data of the moving picture file are configured in a chunk type used in the MP4 file, and the sub video streams are configured in any one of user-defined types.

Any one of the user-defined types may be decoded and displayed by the moving picture recording/reproducing apparatus, but may not displayed by the moving picture recording/reproducing apparatus which does not perform the display of the sub video streams. Therefore, the moving picture recording/reproducing apparatus which does not perform the display of the sub video streams may reproduce the main video streams without error.

Next, when the user selects any one file of the files stored in the storage unit 40, the selected file is extracted from the storage unit 40 and the extracted file is separated into the main video streams and the sub video streams.

It is determined in operation 104 whether the user has input a browsing instruction. If it is determined that the user has input the browsing instruction, the sub video streams of the file are decoded and reproduced in the second display region 52 of the display unit 50 in operation 105.

When the sub video streams are decoded and reproduced, the main video streams may be simultaneously decoded and reproduced.

The second display region 52 of the display unit 50 continuously displays the current sub video frame, the previous sub video frame and the subsequent sub video frame (dual decoding). Therefore, the user may easily browse the picture so as to easily browse the separated position when the picture is edited. That is, the picture may be browsed while skipping one frame or several frames.

Since multiple sub video streams at the predetermined resolution are continuously displayed, the picture may be rapidly browsed. Since the sub video streams are at the predetermined resolution, the sub video streams do not apply heavy load to the storage unit 40.

The display unit 50 may recognize the dragging operation of the user's finger. Thus, when the dragging operation of the user's finger is performed, the frame moves to a previous or next frame in correspondence with the dragged direction.

Next, it is determined in operation 106 whether the user has input an editing instruction. If it is determined that the user has input an editing instruction, the picture selected by the browsing of the picture is recognized as the picture to be edited.

It is determined whether the user inputs the editing instruction such as the removing, dividing, or pasting instruction. If it is determined that the user inputs the editing instruction, the editing function corresponding to the input editing instruction is performed.

More specially, if the user selects any one sub video stream, the position of the selected sub video stream is determined and the stream set corresponding to the selected sub video stream is separated from the file in operation 107.

The stream set (the main video streams, the audio data, and the sub video streams) corresponding to the separated sub video stream is removed if the editing instruction input by the user indicates removal, and the stream set corresponding to the separated sub video stream is separated if the editing instruction input by the user indicates division. When the user selects a position, the separated stream set is pasted at the selected position.

The stream set having the selected sub video stream is removed, separated, or pasted according to at least one of the editing functions such as the removal, separation, and pasting so as to generate a new moving picture file in operation 108. The generated moving picture file is re-recorded and stored in the storage unit 40.

A sub video picture selected by a user corresponds to a position where a picture to be removed, separated, or pasted is separated from the file when the editing of the file is performed.

As shown in FIG. 5, when the moving picture is separated on the basis of the position of the selected sub picture stream, the stream set having the selected sub video stream is separated from the file. That is, a picture desired by the user is browsed using the sub video stream, the separated position is specified, and the picture is separated from the file according to the separated position.

Since the main video stream is separated from the file on the basis of the position of the browsed sub video stream so as to generate the new moving picture, the picture may be efficiently browsed and edited.

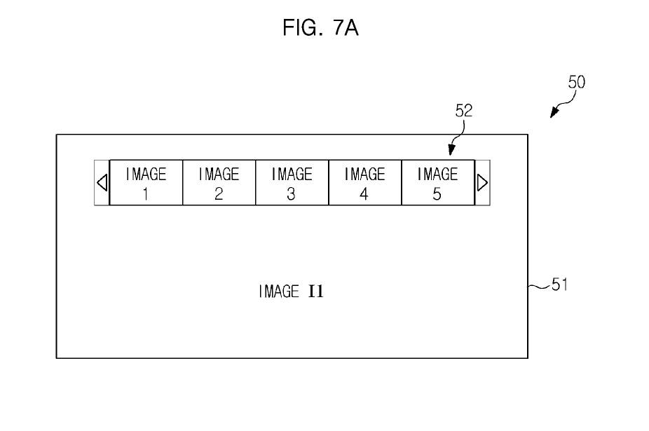

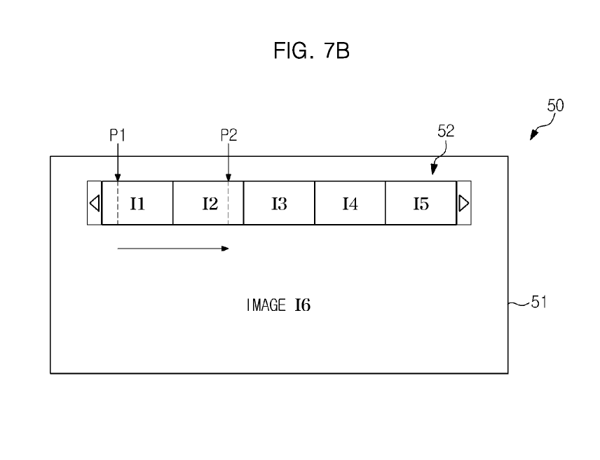

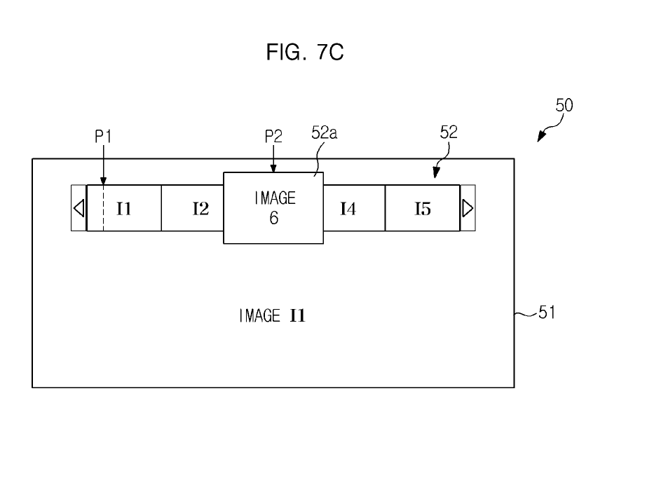

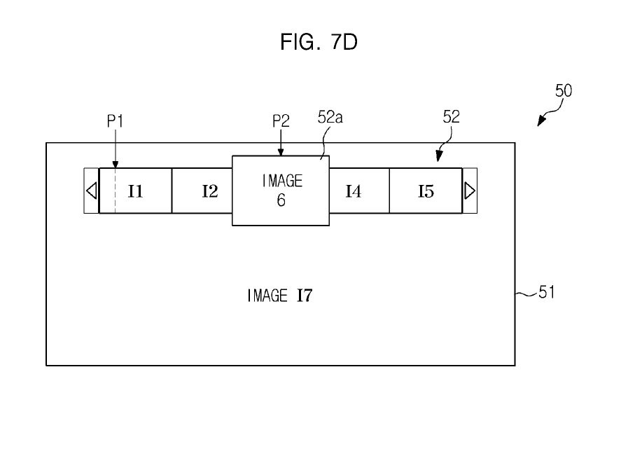

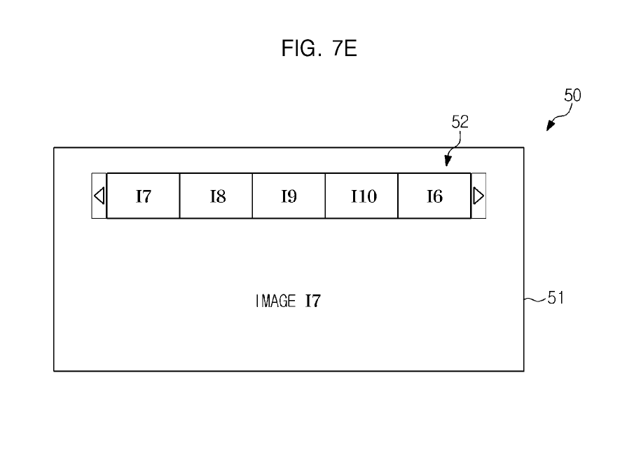

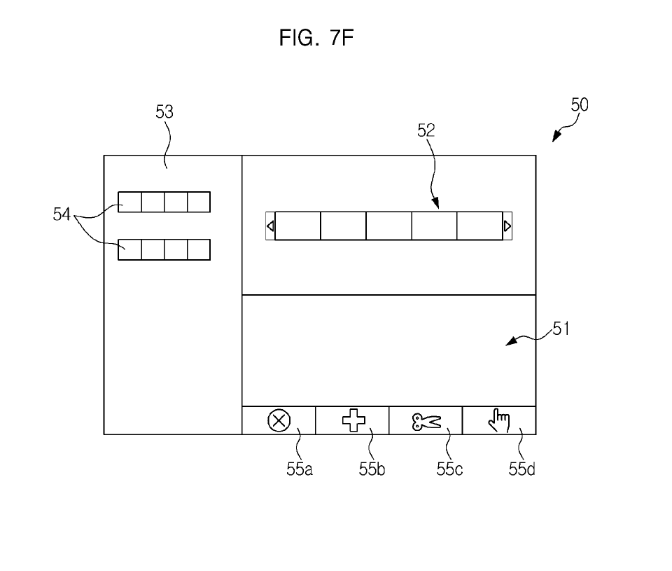

FIGS. 7A-7F illustrate displays of sub video and main video according to embodiments of the present general inventive concept.

In FIG. 7A, the display unit 50 may display a plurality of images 1 through 5, also referred to as I1-I5, corresponding to images of the sub video stream at various locations of the sub video stream. The images 1-5 may correspond to images at various set time intervals of the sub video stream, such as every 5 seconds, every thirty seconds, or every minute. In such a case, a sub video stream corresponding to a moving image having a longer length may have a larger number of images displayed in the second display region 52. For example, a short video may result in a second display region 52 having only five images displayed, while a long video may result in a second display region 52 having more than five images displayed. Alternatively, the images 1-5 may correspond to time intervals that change according to the length of the sub video stream. For example, the display region 52 may be set to display only a predetermined number of image frames. Consequently, a time separation between the images 1-5 may be only five seconds for a moving image having a shorter duration or may be more than five seconds for a moving image having a longer duration.

In FIG. 7B, points P1 and P2 correspond to points selected by a user. For example, a user may select point 1 by using a finger, cursor, or other selection method, and may drag the selection to the point P2. However, any other selection method may be used. The image 6 displayed in the first display region may correspond to the image at the point P2. For example, if the images I1-I5 correspond to images at 10 second intervals of the sub video stream, then the image 12 may correspond to an image at about a 10 second point of the sub video stream (since image I1 corresponds to a time 0), and point P2 and image I6 may correspond to an image at about a 13 second point of the sub video stream.

FIGS. 7C and 7D illustrate alternative methods of displaying selected portions of the sub video stream. In FIG. 7C, the image I1 displayed on the first display region 51 corresponds to the first image of the sub video stream. The image corresponding to the first selected point P1 is not displayed. The image 16 corresponding to the second selected point P2, or the point corresponding to an end of a selected sub video stream set, is enlarged compared to the remaining images I1-I5 to allow a user to better view the image I6. Alternatively, in FIG. 7D the image I7 that corresponds to the first selected point P1 is displayed on the first display region 51.

As illustrated in FIG. 7E, once a portion of the sub video stream has been selected, the selected portion may be separated from the rest of the sub video stream and may be displayed as a separate video stream to be edited. In other words, the display of the second display region 52 is changed to begin at the image I7 corresponding to the selected start point P1, and to end at the image I6 corresponding to the selected end point P2. Images I8, I9, and 110 correspond to images at predetermined intervals between I7 and I6.

FIG. 7F illustrates a display unit 50 having a “selected clip” pane 53 in which a user may store selected clips for future use. For example, a user may paste a selected portion of a sub video stream to a selected clip 54, or may select a portion of a selected clip 54 for further editing in the first display region 51. Alternatively, after selection of a portion of the sub video stream, in FIG. 7D, for example, a new display may be generated to edit the selected portion.

According to the display of FIG. 7F, icons 55a, 55b, 55c, and 55d may be provided to delete a selected sub video stream, add or paste a selected sub video stream to another sub video stream, cut a selected sub video stream, or move a selected sub video stream. In other words, when a user selects portions of a video stream set by using the displayed sub video images, the main video stream is also selected and deleted, pasted, cut, or moved according to the user commands.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A method of controlling video streams, the method comprising:
generating main video streams corresponding to a photographed moving picture;
generating sub video streams by reducing a resolution of the main video streams;
multiplexing the main video streams and the sub video streams to generate one file; and
storing the generated file.

2. The method according to claim 1, wherein the generating of the sub video streams includes:
extracting I-frames from the main video streams; and
reducing a resolution of the I-frames to a predetermined resolution.

3. The method according to claim 2, wherein the predetermined resolution is 160*90 or less.

4. The method according to claim 1, wherein the generating of one file includes generating a moving picture file including dual streams.

5. The method according to claim 1, wherein the generating of one file includes generating an MP4 file.

6. The method according to claim 1, further comprising:
determining whether a user inputs a browsing instruction; and
decoding and displaying the sub video streams if it is determined that the user inputs the browsing instruction.

7. The method according to claim 6, further comprising:
determining whether the user inputs an editing instruction;
determining whether a picture to be edited is selected upon determining that the user inputs the editing instruction; and
separating the selected picture from the file upon determining that the picture to be edited is selected.

8. The method according to claim 7, further comprising removing or pasting the separated picture according to a user instruction.

9. The method according to claim 6, wherein the decoding and displaying of the sub video streams includes decoding and displaying the main video streams.

10. A moving picture apparatus comprising:
a stream generator to generate main video streams of a photographed moving picture and to lower a resolution of the main video streams to generate sub video streams;
a file generator to multiplex the main video streams and the sub video streams to generate one file;
a storage unit to record and store the file; and
a display unit to reproduce the file.

11. The moving picture apparatus according to claim 10, further comprising:
an input unit to enable a user to input a browsing instruction; and
an extractor to extract the main video streams and the sub video streams from the file when the browsing instruction is input,
wherein the display unit displays the sub video streams.

12. The moving picture apparatus according to claim 10, further comprising:
an input unit to enable a user to input an editing instruction; and
an extractor to extract the main video streams and the sub video streams from the file when the editing instruction is input; and
an editing unit to separate a selected picture from the file so as to regenerate a file when the user selects a picture to be edited,
wherein the display unit displays the extracted sub video streams, and
the storage unit re-records the regenerated file.

13. The moving picture apparatus according to claim 10, wherein the stream generator generates dual streams in at least one of Standard Definition (SD) and High Definition (HD).

14. The moving picture apparatus according to claim 10, wherein the stream generator extracts I-frames from the main video streams and lowers a resolution of the I-frames to a predetermined resolution.

15. The moving picture apparatus according to claim 14, wherein the predetermined resolution is 160*90 or less.

16. The moving picture apparatus according to claim 10, wherein the display unit includes a first display region in which the main video streams are reproduced and a second display region in which the sub video streams are reproduced.

17. The moving picture apparatus according to claim 10, wherein the file generator generates the main video streams in a chunk type of an MP4 file and generates the sub video streams in a user-defined type of the MP4 file.

18. The moving picture apparatus according to claim 10, wherein the file generator positions the sub video streams at positions close to the I-frames of the main video streams.

19. A method of controlling a video stream, comprising:
receiving moving image data;
generating a first video stream at a first resolution based on the moving image data; and
based on the first video stream, generating a second video stream at a second resolution less than the first resolution, the second video stream corresponding to predetermined frames located at predetermined intervals within the first video stream.

20. The method of claim 19, further comprising:
multiplexing the first video stream and the second video stream into a single file.

21. The method of claim 20, further comprising:
storing the single file in a storage unit.

22. The method of claim 20, wherein multiplexing the first video stream and the second video stream comprises:
locating a frame of the second video stream at a predetermined location with respect to a corresponding frame of the first video stream; and
locating audio data at a predetermined location with respect to each of the frames of the first and second video streams.

23. The method of claim 22, further comprising:
displaying a plurality of frames of the second video stream;
receiving an input to select at least one of the frames of the second video stream; and
based on the selection of the at least one frame of the second video stream, accessing at least one frame of the first video stream corresponding to the selected at least one frame of the second video stream.

24. The method according to claim 22, further comprising:
locating the frame of the second video stream immediately preceding the corresponding frame of the first video stream.

25. The method according to claim 19, wherein the first video stream is generated by generating predicted frames between intra-frames that include complete images, and
the second video stream includes frames that correspond only to the intra-frames of the first video stream.

26. A method of controlling a video stream, comprising:
receiving moving image data;
based on the moving image data, generating a first video stream at a first resolution;
based on the first video stream, generating a second video stream at a second resolution less than the first resolution; and
multiplexing the first and second video streams to generate a single file.

27. An imaging device, comprising:
a stream generator to receive moving image data, to generate a first video stream at a first resolution based on the moving image data, and to generate a second video stream at a second resolution less than the first resolution based on the first video stream, frames of the second video stream corresponding to frames of the first video stream located at predetermined intervals with respect to each other.

28. The imaging device according to claim 27, further comprising:
a file generator to multiplex the first and second video streams to form a single file.

29. The imaging device according to claim 28, further comprising:
a storage unit to store the single file.

30. The imaging device according to claim 29, further comprising:
a stream extractor to extract the second video stream from the single file stored in the storage unit.

31. The imaging device according to claim 30, further comprising:
an editing unit to edit a portion of the first video stream corresponding to a selected portion of the second video stream.

32. The imaging device according to claim 31, further comprising:
a display unit to display a plurality of frames of the second video stream extracted by the stream extractor.

33. The imaging device according to claim 31, further comprising:
an input unit to receive an input to select the portion of the second video stream to edit the corresponding portion of the first video stream.

34. The imaging device according to claim 27, further comprising:
a moving picture collection unit to convert received light into the moving image data.

35. An imaging device, comprising:
a stream generator to receive moving image data, to generate a first video stream at a first resolution, and to generate a second video stream at a second resolution based on the first video stream; and
a file generator to multiplex the first video stream and the second video stream into a single file.
